(19) United States
(12) Patent Application Publication
(10) Pub. No.: US 2015/0330534 A1
(43) Pub. Date: Nov. 19, 2015

(54) BUNDLED PIPE AND METHOD OF MANUFACTURE

(71) Applicants: TherCom Holdings, LLC, Bloomfield Hills, MI (US); Crescent Point Energy Corp., Calgary (CA)

(72) Inventors: Joel A. Dyksterhouse, Cross Village, MI (US); Mohammed Rashad Abdo Qaid, Calgary (CA); James Robert Hunter, Calgary (CA); Ryan Thomas McDowell, Calgary (CA)

(73) Assignees: TherCom Holdings, LLC, Bloomfield Hills, MI (US); Crescent Point Energy Corp., Calgary (CA)

(21) Appl. No.: 14/280,943

(22) Filed: May 19, 2014

(51) Int. Cl. F16L 7/00; B29D 23/00; B29C 47/00

(52) U.S. Cl. CPC F16L 7/00; B29C 47/0028; B29D 23/00; B29K 2301/12

(57) ABSTRACT

The specification discloses a multi-stage injection pipe and method for manufacturing a multi-stage injection pipe. The multi-stage injection pipe includes a plurality of thermocomposite high pressure pipes and a thermocomposite tendon. A jacket surrounds the high pressure pipes and the tendon. The space between the jacket and the high pressure pipes is filled with a matrix material having the same polymer chemistry as the high pressure pipes, the tendon, and the jacket. The multi-stage injection pipe is manufactured by co-extruding the high pressure pipes, the tendon, the matrix material and the jacket, and then allowing the components to bond to one another to maintain the high pressure pipes in position.

### BACKGROUND OF THE INVENTION

The present invention relates to bundled pipes and to methods for manufacturing bundled pipe.

Injection pipes are used in secondary recovery processes (i.e. hydraulic fracturing or “fracking”) to collect natural resources, such as petroleum or oil, from underground reservoirs. During primary recovery processes, the petroleum is typically collected from a well in the reservoir. As the petroleum is drawn from the well, the pressure in the reservoir drops and the rate at which the petroleum can be pumped from the ground slows or stops. The secondary recovery process involves the pumping of fluids, typically water, into the reservoir through injection wells in order to re-establish the pressure in the reservoir required to continue or restart the process of extracting the petroleum. The secondary recovery process substantially increases the quantity of the resource recovered, thereby providing better economic return on the cost of establishing a productive well.

The economic return on the cost of the secondary recovery process may be further improved by use of horizontal well technology. This technology involves providing a single vertical well and a horizontal drill string to reach a larger portion of the reservoir through multi-stage hydraulic fracturing. However, additional issues arise in the secondary recovery efforts with this technology due, at least in part, to the natural variability of the rock properties, along with the relative proportions of the fluids saturating them. This variability can cause generalized areas of uneven flow rates and corresponding uneven pressures for fluids that are injected along a horizontal well. The injected fluids will follow a path of least resistance between two points, known as channeling, potentially leaving large portions of the reservoir without the benefit of the injected fluids.

To improve the effectiveness of the horizontal techniques, multiple steel pipes have been individually attached to elements known as “packers” to isolate specific sections of the wellbore and to thereby provide fluid at different rates and pressures into different sections of the reservoir. However, the size restrictions of the main well bore make this solution costly both in terms of installation and service because each component must be run individually and in sequence. Additionally, there are physical limits to the distance steel pipes may be pushed horizontally underground.

### SUMMARY OF THE INVENTION

At least some of the problems noted above are overcome by the present invention providing bundled pipe including a plurality of high pressure tubing or pipes within a matrix and surrounded by an outer jacket. The method for manufacturing the bundled pipe includes feeding high pressure pipes to an extrusion die and co-extruding the pipes with a matrix material and an outer jacket material such that the matrix material fills the void space between the pipes inside the jacket.

In an embodiment, the high pressure pipes define an inter-pipe space and bundled pipe further includes a tendon located within the inter-pipe space.

In an embodiment, a tow line is embedded in the matrix material. The tow line may be a wire, cable, and/or fiber optic material.

In an embodiment, the high pressure pipes are constructed of thermocomposite materials.

In an embodiment, at least one of the plurality of high pressure pipes includes points of pipe weakness adapted to rupture and allow fluid flow therethrough from the high pressure pipe to a space external to the bundled pipe.

In an embodiment, the method of manufacturing includes the steps of: producing a fiber reinforced thermoplastic pipe; introducing a plurality of spaced apart areas of weakness along a length of the thermoplastic pipe; and positioning a plurality of the thermoplastic pipes within an extrusion die; co-extruding a matrix material about the pipes; and co-extruding an outer jacket around the plurality of thermoplastic pipes and the matrix material.

In an embodiment, the method further comprises the step of co-extruding a tendon with the thermoplastic pipe and the matrix material.

In a further embodiment, the method includes fabricating the thermoplastic pipe and the tendon from the same thermocomposite.

These and other advantages and features of the invention will be more fully understood and appreciated by reference to the description of the current embodiment and the drawings.

### BRIEF DESCRIPTION OF THE DRAWINGS

FIG. 1 is a cross-section of the bundled pipe;

FIG. 2 is a schematic illustration of a prior art secondary resource recovery process;

FIG. 3 is a schematic illustration of the use of the bundled pipe in a multi-stage secondary resource recovery process;

FIG. 4 is a flow diagram of a method of manufacturing the bundled pipe; and

FIG. 5 is a flow diagram of a method of manufacturing a bundled pipe with points of weakness.

### DESCRIPTION OF THE CURRENT EMBODIMENT

Before the embodiments of the invention are described, it is to be understood that the invention is not limited to the details of operation or to the details of construction and the arrangement of the components set forth in the following description or illustrated in the drawings. The invention may be implemented in various other embodiments and is capable of being practiced or being carried out in alternative ways not expressly disclosed herein.

Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

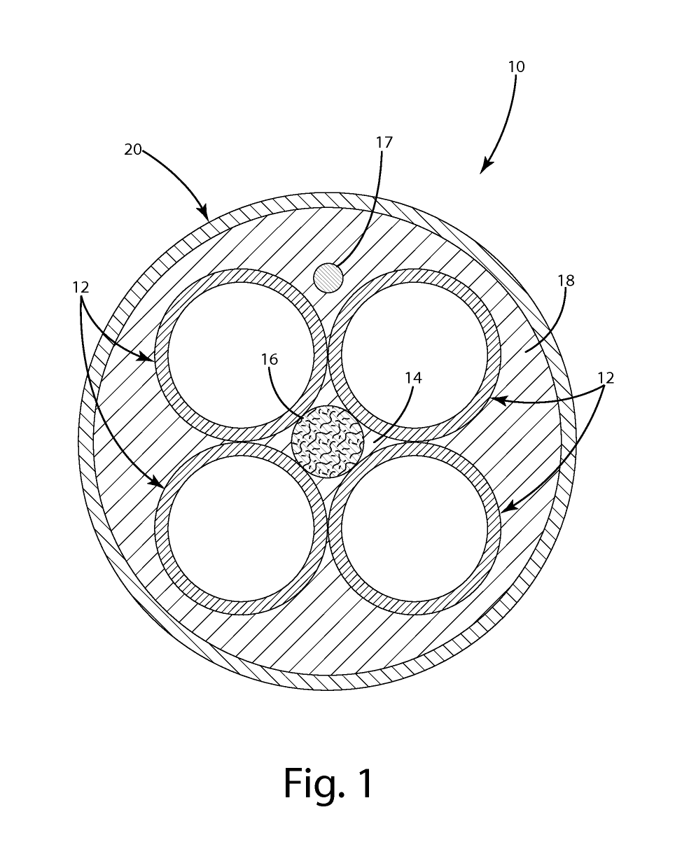

The bundled pipe or multi-stage injection pipe is shown in the cross-sectional view of FIG. 1 generally designated as 10. The injection pipe 10 may include one or more high pressure pipes or tubes 12. In the illustrated embodiment, the high pressure pipes 12 are bundled and form an inter-tubal or inter-pipe space 14. Within the inter-pipe space 14 of FIG. 1 is shown a tendon 16. If desired, the multi-stage injection pipe 10 may be constructed with any number of additional tows such as a cable, wire, or fiber optic material 17. A matrix material 18 fills the voids between the pipes 12 and tendon(s) and/or additional tows 17, if present. All high pressure tubes or pipes 12 and any associated tendon(s) 16 or tow(s) 17 may be encased in a co-extruded jacket or outside wall 20.

The high pressure pipes may be constructed of fiber reinforced thermoplastic, for example a helically would thermocomposite tape. The fibers may be any one of a variety of materials such as directional fibers and/or woven fibers, including for example carbon, aramid, fiberglass such as E-glass or S-glass, aramid, spectra, carbon, aluminum, titanium, or combinations thereof. The thermoplastic matrix material may include resins such as, but not limited to, polyamide, polyethylene terephthalate, polyphenylene sulfide, polypropylene, nylon, ABS, polybutylene terephthalate, polysulfone, or polycarbonate. The resulting fiber orientations within the resin may range from zero degrees (oriented with the longitudinal axis of the tape) to 90 degrees, and the fiber may be bi-axial, multi-axial, woven or braided.

The choice of resin impacts chemical resistance, vapor transmissivity, temperature resistance, toughness, UV resistance as well as other physical properties. The fiber and orientation combinations impact pressure or burst strength, modulus of elasticity and compression under load. The tape angle, number of plies or coils in the finished structure will control tensile strength, modulus (ductility) of the structure and wall thickness which can affect at least some of the above listed properties.

The thermoplastic matrix material may be syntactic foam or a closed cell thermoplastic and may include resins such as, but not limited to, polyamide, polyethylene terephthalate, polyphenylene sulfide, polypropylene, nylon, ABS, polybutylene terephthalate, polysulfone, or polycarbonate.

The individual high pressure pipes 12, 212 may have a relatively small diameter (in comparison to the complete bundled pipe 10) such as between about 25 mm and about 50 mm OD in the current embodiment. More specifically the OD may be between about 30 and about 40 mm OD. But the pipe may have a wide range of diameters depending on the application. The pipes 12, 212 may be constructed of multiple wraps or multiple materials depending upon the mechanical and thermal properties needed, including mechanical strength and burst pressure. The overall diameter of the jacket 20, 220 may be sized so that the internal diameter (“ID”) contacts a portion of the circumferential surface of each high pressure pipe 12, 212. For example the OD of the jacket 20, 220 may be between about 50 mm and about 100 mm. Alternatively, the diameter of the jacket 20, 220 may be sized so that the jacket 20, 220 does not contact selected ones or any of the high pressure pipes 12, 212.

### Use

The multi-stage injection pipe 10 is useful in systems requiring the pressurized injection of a fluid, such as water for example, into a porous material. An example of a system requiring such an injection of fluid is the secondary recovery process in a horizontal, multi-stage hydraulic fracturing scheme sometimes used to increase the yield of material from a natural resource reservoir, such as an oil field for example.

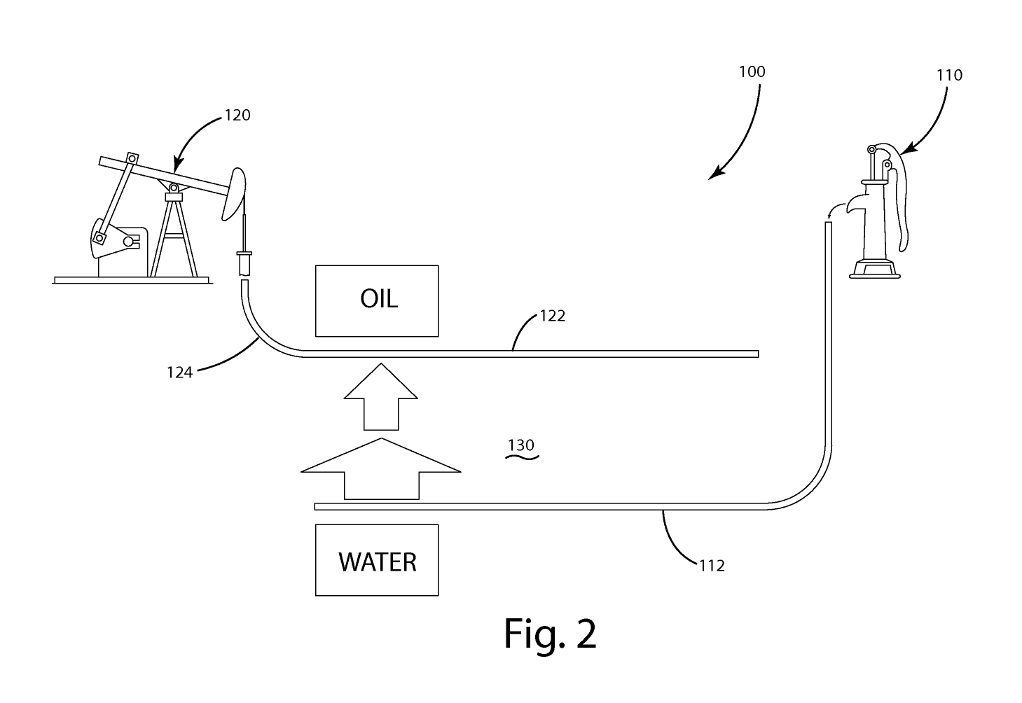

Referring to FIG. 2, a prior art horizontal, fracturing system 100 is shown with a fluid source 110 and resource collection pump 120. The resource collection pump 120 is capable of extracting fluid such as oil from a volume of material, such as porous subsurface 130 of earth such as shale, for example. The pump 120 is in communication with a collection pipe 122 in the subsurface 130. In a horizontal well system the fluid resource is initially extracted from the subsurface 130 through the collection pipe 122 due to the porous nature of the collection pipe and aided by a pressure gradient created by a boring 124. As the resource is extracted by the pump 120 the pressure in the subsurface 130 drops and the flow of the resource from the subsurface 130 will slow or cease. However, the process of extracting the resource from the subsurface may be revived or continue when additional fluid is introduced to the subsurface 130 thereby raising the pressure. For example, the fluid source 110 may introduce a fluid, such as water, through tubing or a pipe 112 into the subsurface 130 as a pressure maintenance measure. When adequate pressure is maintained in such a system, the economic value of an individual fracturing system 100 may be greatly increased.

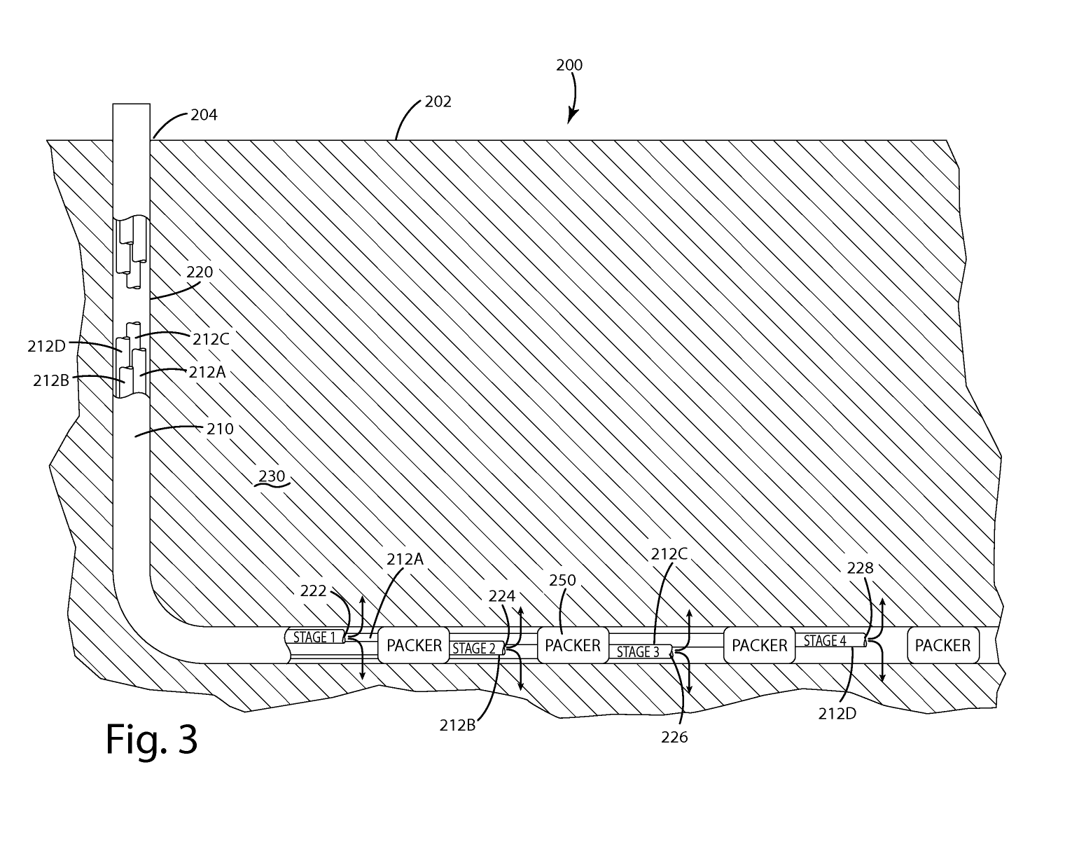

Multi-stage injection in hydraulic fracturing is shown in FIG. 3 as it may be configured within a horizontal well system 200. A vertical wellbore 204 and a horizontal drill string 206 are created using conventional drilling techniques. The present multi-stage injection pipe 210 may be inserted into the vertical well bore 204 and the horizontal drill string 206. In the illustrated embodiment, the multi-stage injection pipe 210 includes four internal high pressure tubes or pipes 212(a)-212(d) bundled inside a jacket 220. The multi-stage injection pipe 10, 210 may be installed with packers 250, if desired, that aid in isolating regions within the reservoir.

Each of the high pressure pipes 212(a)-212(d) and the jacket 220 may include points of weakened strength 222, 224, 226, 228. These weaker points may be punctured or otherwise created at desired locations during inserting of the bundled pipe into the well, or the points may be designed and adapted to burst after having been placed in the drill string, such as by providing a specific burst pressure that is below the designated operating pressure. The latter option allows the entire pipe 10, 210 to remain sealed during installation and subsequently burst at predetermined points prior to commencement of operation. Because the materials of the high pressure pipes 12, 212, the tendon 16, and the matrix 18 are of the same or compatible chemical polymer, the homogeneity of the components assists in preventing separation of the components and aids in directing the fluid in the high pressure pipes 12, 212 into the reservoir rather than into the injection pipe 10, 210.

### Manufacture

Once formed, lengths of between about 2,000 and about 20,000 feet of the reinforced thermoplastic tubes or pipes 12, 212 may be coiled or spooled on reels. At any point between the formation process and spooling process, the tubes or pipes 12, 212 may be dimpled or otherwise provided with spaced apart points of weakened strength 406 in the circumferential wall. These isolated weakened points may provide points at which the pipes 12, 212 may be perforated, along with the jacket 20, 220 to provide a port for the outflow of fluid as described herein above.

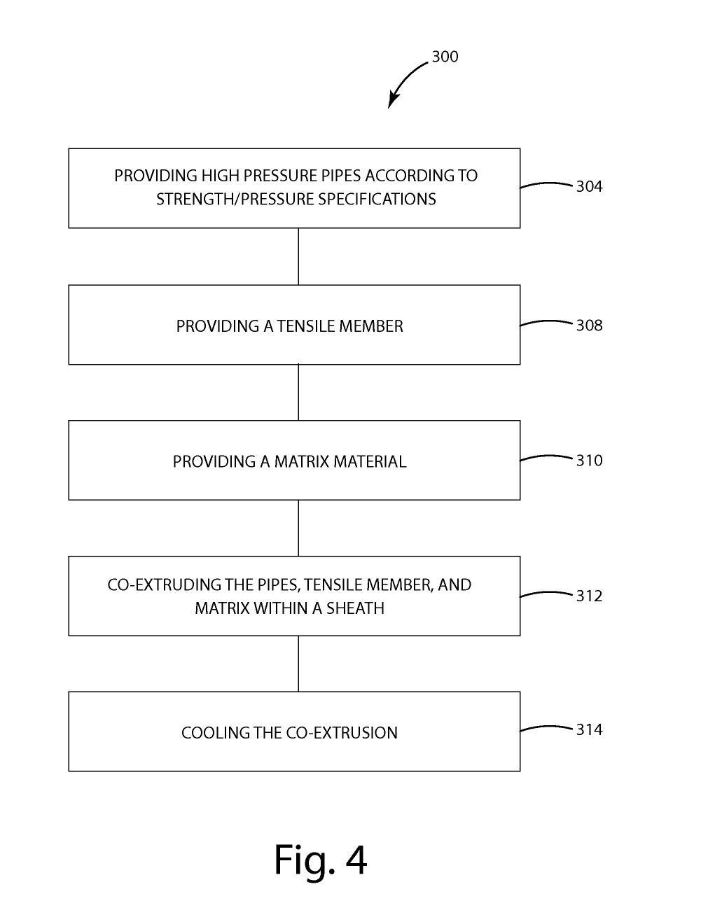

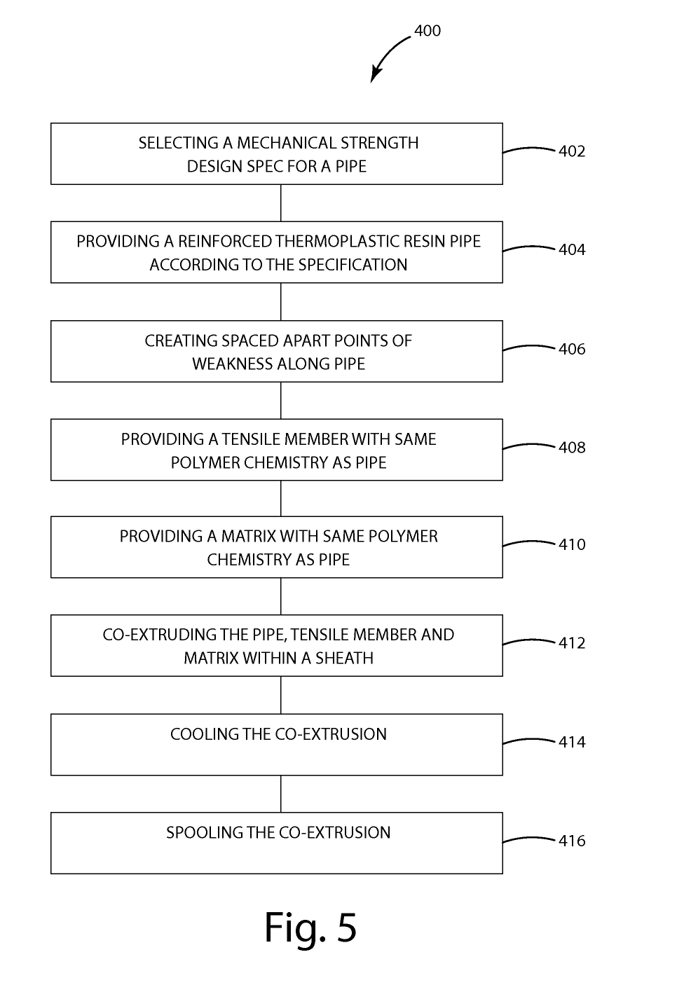

FIGS. 4-5 are flow charts of example processes 300, 400 for manufacturing the multi-stage injection pipe 10, 210. One or more specifications for the high pressure pipes 12, 212 may be selected 402. The pipes 12, 212 are provided according to desired specifications 304, 404 which include, for example, a stiffness or mechanical strength. The stiffness or mechanical strength is selected to enable the multi-stage injection pipe 10, 210 to be pushed into the vertical well bore 204 and the horizontal drill string 206 without collapsing under compression forces while still retaining sufficient burst pressure to be able to flood a subsurface 130, 230 such as a shale formation.

The manufacturing methods 300, 400 may further include providing a tensile member 308, 408 and a matrix material 310, 410 having the same, similar or compatible polymer chemistry as the high pressure pipes 12, 212. The leading ends of the pipes 12, 212 may be placed at the entry of an extrusion die. As disclosed, the bundled pipe 10 includes four pipes 12, 212; however, any number of pipes can be included depending on the application and a desired configuration. The pipe 12, 212 may be placed as desired in multiple locations of the die. Further, if desired, one or more tendons 16 constructed from the same thermocomposite as the pipe 21, 212 may be located at an entry to the extrusion die. The separate and individual tubes or pipes 12, 212 and tendon 16 may be positioned to maintain their relative positions and alignment with respect to one another with the extrusion die and within the final multi-stage injection pipe 10, 210. The maintaining of position of the individual pipes 12, 212 within the jacket 20, 220 relative to one another may be helpful for maintaining alignment of the points of weakness in the internal pipes 12, 212 and the jacket 20, 220 and may ease the task of identifying the location of a particular individual high pressure pipe 12, 212 when creating the point of weakness.

The fill or matrix material 18 polymer resin that is preferably of the same chemistry as the tendon(s) 16 and pipes 12, 212 may be extruded into the cavities around and throughout the one or more pipes 12, 212 and tendon(s) 16. The fill material 18 may be a pure thermoplastic polymer or may contain additives such as glass microspheres [other fillers?] that would that assist the overall structure to be light in weight while maintaining a homogenous nature with the other components, thereby maintaining the pressure requirements of the multi-stage injection pipe 10, 210. The polymer resin preferably is melted during the extrusion process so that subsequent freezing integrally binds the pipes 12, 212 and tendons 16.

During the co-extrusion 312, 412 of the tubes or pipes 12, 212 with the tendon(s) 16 and matrix material 18 there may be a sheath or jacket 20, 220 extruded as well such that the high pressure pipes 12, 212, tendon 16 and matrix 18 are contained within the jacket 20, 220. It may be desired to cool the individual tubes or pipes 12, 212 to prevent melting or collapse of the tubing 12, 212 under the pressure and temperature of extrusion. This cooling may be accomplished by supplying a flow of air or liquid through the tubing or pipes 12, 212 during the co-extrusion process. When the tendon 16 is constructed from the same polymer matrix as the other components, all of the components intimately bond, creating the mechanical strength required to push the multi-stage injection pipe 210 into and within the well bore 204 and the horizontal drill string 206.

The tubing or pipes 12, 212, tendons 16 and matrix material 18 maybe further extruded with a sheath or jacket 20, 220. The jacket 20, 220 may further control the dimensions, lubricity and permeation of the final multi-stage injection pipe 10, 210. The jacket 20, 220 may be constructed of the same or similar polymer as the tubing or pipes 12, 212, tendon 16 and matrix material 18. The sheath or jacket 20, 220 may be coated over the tubes or pipes 12, 212 in a manner allowing for the location of the individual pipes 12, 212 to be determined externally on the jacket 20, 220 of the multi-stage injection pipe 10, 210. This identification of the location of the individual tubes or pipes 12, 212 from a perspective outside the multi-stage injection pipe 10, 210 may be accomplished by providing a color, imprint or groove in the multi-stage injection pipe 10, 210 on the jacket 20, 220.

After the final multi-stage injection pipe 10, 201 is adequately cooled 314, 414, it may be spooled, coiled or reeled 416 for shipment. If two or more reels are needed, a mechanical connection may be required to join the different reeled lengths of injection pipe 10, 210. Preferably, the mechanical connection between internal high pressure pipes 12, 212 is to be stronger than the burst pressure of the pipes 12, 212. A composite overwrap may be provided to cover any joints between the pipes 12, 212 and mechanical connectors (not shown) to aid in the maintenance of position of the connectors.

If desired, the multi-stage injection pipe 10, 210 may further include a length of wire, cable or other material such as a fiber optic material towed through extrusion die during the manufacture of the multi-stage injection pipe 10, 201. The wire, cable or fiber optic strand 17 may be used to facilitate surveillance or monitoring of conditions such as temperature and pressure within or surrounding the multi-stage injection pipe 10, 210.

The above description and variations are those of a current embodiment of the invention. Various alterations and changes can be made without departing from the spirit and broader aspects of the invention as defined in the appended claims, which are to be interpreted in accordance with the principles of patent law including the doctrine of equivalents.

This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative.

Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims.

Any reference to claim elements in the singular, for example, using the articles “a,” “an,” “the” or “the,” is not to be construed as limiting the element to the singular.

1. A bundled pipe comprising:
a plurality of high pressure pipes fabricated of a thermocomposite;
an outer jacket fabricated of a first thermoplastic and surrounding the pipes; and
a matrix material fabricated of a second thermoplastic and bonded to the jacket and the pipes, whereby the matrix material maintains the pipes in position with respect to one another and to the jacket.

2. The bundled pipe of claim 1 wherein:
the plurality of high pressure pipes define an inter-pipe space; and
the bundled pipe further comprises a tendon fabricated of a second thermocomposite, the tendon located within the inter-pipe space and bonded to the matrix material.

3. The bundled pipe of claim 1 further comprising a tow line within the matrix material.

4. The bundled pipe of claim 3 wherein the tow line comprises at least one of a wire, a cable, and a fiber optic material.

5. The bundled pipe of claim 1 wherein each of the plurality of high pressure pipes further comprises spaced apart points of pipe weakness adapted to rupture at a preselected pipe pressure.

6. The bundled pipe of claim 5 wherein the outer jacket includes a point jacket weakness corresponding to each point of pipe weakness.

7. The bundled pipe of claim 1 wherein the matrix material comprises a closed cell foamed thermoplastic.

8. The bundled pipe of claim 1 wherein the high pressure pipes have a burst pressure higher than 2000 psi.

9. A method of manufacturing a multi-stage bundled pipe comprising the steps of:
producing thermocomposite pipe;
directing a plurality of the thermocomposite pipes through an extrusion die;
co-extruding a thermoplastic matrix material with the thermocomposite pipes;
co-extruding a thermoplastic outer jacket around the plurality of thermoplastic pipes and the matrix material; and
allowing the matrix material to bond to the thermocomposite pipes and the matrix material, whereby the thermocomposite pipes are maintained in position relative one another.

10. The method of claim 9 wherein the producing step includes creating a point of weakness in the thermocomposite pipe.

11. The method of claim 10 wherein the producing step includes producing the thermocomposite pipe with a minimum burst pressure.

12. The method of claim 11 wherein the minimum burst pressure is higher than 2000 psi.

13. The method of claim 11 wherein the producing step includes producing the thermocomposite pipe with a minimum mechanical strength.

14. The method of claim 11 further comprising the step of co-extruding a tendon within the matrix material.

15. The method of claim 14 wherein:
the tendon comprises a thermocomposite material; and
the allowing step includes allowing the matrix material to bond to the tendon.

16. The method of claim 14 wherein the thermocomposite pipe and the tendon comprise the same polymer.

17. The method of claim 9 further comprising the step of co-extruding a tow line with the thermocomposite pipes and the matrix material.

18. The method of claim 9 further comprising the step of spooling the thermocomposite pipe prior to directing the plurality of thermocomposite pipes through the extrusion die.

20. A bundled pipe produced by the method of claim 9.
